(19) United States
(12) Patent Application Publication
(10) Pub. No.: US 2009/0154696 A1
(43) Pub. Date: Jun. 18, 2009

(54) System and Method for Secure Keypad Protocol Emulation in a Fuel Dispenser Environment

(75) Inventors: Philip A. Robertson, Greensboro, NC (US); William C. Royal, Oak Ridge, NC (US)

Correspondence Address: NELSON MULLINS RILEY & SCARBOROUGH, LLP, 1320 MAIN STREET, 17TH FLOOR, COLUMBIA, SC, 29201, US

(73) Assignee: Gilbarco Inc., Greensboro, NC (US)

(21) Appl. No.: 12/265,110

(22) Filed: Nov. 5, 2008

Related U.S. Application Data
(60) Provisional application No. 60/985,514, filed on Nov. 5, 2007.

(51) Int. Cl. H04L 9/00

(52) U.S. Cl. 380/52

(57) ABSTRACT

A system used in a retail environment, such as a fuel dispensing environment, for providing secure communication of payment information to a host computer. The system includes at least one keypad device configured to receive and encrypt personal information according to a first encryption scheme to produce encrypted personal data. The keypad device is further operative to generate a local zone emulated message in a message format of a second encryption scheme, the local zone emulated message containing the encrypted personal data. A site controller is in communication with the keypad device to receive the local zone emulated message. The site controller is configured to provide a message in the second encryption scheme to a security module for decryption and re-encryption in the first encryption scheme. An emulator is associated with the site controller to emulate the security module. In this regard, the emulator is operative to receive the local zone emulated message and return the encrypted personal data without decryption. The site controller provides the encrypted personal data to the host computer according to the first encryption scheme.

### PRIORITY CLAIM

This application claims the benefit of provisional application Ser. No. 60/985,514, filed Nov. 5, 2007, which is hereby relied upon and incorporated herein by reference.

### BACKGROUND OF THE INVENTION

The present invention relates generally to fuel dispensers having the ability to accept payment at the dispenser. More particularly, the present invention relates to encryption techniques utilized in a fuel dispenser environment to protect sensitive information such as a user's personal identification number (PIN).

Credit card companies (such as VISA® and MASTERCARD®) have been very successful in persuading consumers that credit cards should be used to complete commercial transactions in place of cash. As a result of the success of the credit card, almost every retail establishment now has a magnetic card stripe reader. Concurrent with the proliferation of the magnetic stripe card readers used to process credit cards, many financial institutions have authorized the issuance of debit cards that are interoperable with the magnetic card readers.

Typically, a credit card is swiped through the magnetic card reader, and the credit card owner does not have to take further steps to complete the authorization of the transaction, although some establishments require a signature to complete the transaction. In contrast, a debit card typically requires the card owner to enter, via a keypad, a PIN to complete customer authorization of the transaction since funds are transferred directly from the customer's bank account. The PIN (when present) is typically encrypted at the point of entry and then sent in an encrypted format over open communications links, such as a telephone line, to a host computer for transaction authorization. The encryption is used to protect the PIN from disclosure so that unauthorized persons may not eavesdrop and obtain the PIN in clear form and thus be able to use the PIN in conjunction with the card number to defraud the legitimate card holder, the vendor, or an authorizing institution or card issuer.

Commonly-owned U.S. Pat. No. 5,228,084, incorporated by reference in its entirety, describes the encryption process and teaches a fueling environment where a plurality of fuel dispensers can accept debit cards and PIN entry. The fueling environment is divided into two zones. The first zone is a local zone within the fueling environment. The local zone extends from the data entry point to a security module associated with a site controller. The second zone is the host zone and extends from the security module to the host computer that authorizes the transaction. The PIN is encrypted by the data entry point device (a keypad, a card reader, or the like) using a local encryption algorithm, and is sent to the security module. The security module decrypts the information from the data entry point device using the local encryption scheme and re-encrypts the information according to a host encryption algorithm used by the host computer. After re-encryption, the information is sent to the host computer for transaction authorization.

Card Issuers have recently announced new requirements for encryption of data entered at the keypad. These new requirements mandate encryption of data, including PIN data for debit cards, at the keypad, with a triple Data Encryption Standard (Triple-DES) derived unique key per transaction (DUKPT). It is expected that this change will require substantial modifications and/or upgrades to the equipment deployed at retail establishments.

### SUMMARY OF THE INVENTION

The present invention recognizes and addresses various considerations of the prior art.

One aspect of the present invention provides a system used in a retail environment for providing secure communication of payment information to a host computer. The system comprises at least one keypad device configured to receive personal information. The keypad device is operative to encrypt the personal information according to a first encryption scheme (e.g., encrypted under the debit acquirer, triple-DES DUKPT key) to produce encrypted personal data. The keypad device is further operative to generate a local zone emulated message in a message format of a second encryption scheme, the local zone emulated message containing the encrypted personal data.

The system further includes a site controller in communication with the keypad device to receive the local zone emulated message. The site controller is configured to provide a message in the second encryption scheme to a security module for decryption and re-encryption according to the first encryption scheme. An emulator is associated with the site controller to emulate the security module. In this regard, the emulator is operative to receive the local zone emulated message and return the encrypted personal data without decryption. The site controller provides the encrypted personal data to the host computer according to the first encryption scheme.

Another aspect of the invention provides a system used in a retail environment for providing secure communication of payment information to a host computer. The system comprises at least one keypad device configured to receive personal information. The keypad device is operative to encrypt the personal information according to a host encryption scheme to produce encrypted personal data. A site controller is in communication with the keypad device via a local area network on which the keypad device has a network address. As a result, site controller is operative to receive the encrypted personal data and provide it to the host computer.

Other objects, features and aspects of the present invention are discussed in greater detail below.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a diagrammatic representation of a prior art payment system utilized in a fuel dispensing environment;

FIG. 2 is a diagrammatic representation showing additional details of the prior art user interface in the system of FIG. 1;

FIG. 3 is a diagrammatic representation of a payment system in accordance with an embodiment of the present invention;

FIG. 4 is a flow chart showing data encryption steps in accordance with an embodiment of the present invention;

FIG. 5 is a diagrammatic representation of a payment system in accordance with an alternative embodiment of the present invention; and

FIG. 6 shows portions of a payment system similar to that of FIG. 5 but having certain further modifications.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

The present invention allows triple-DES encryption of personal information such as a PIN or an account number using the acquirer debit or “host key,” at the fuel dispenser or other data entry location. In order to interoperate with existing dual-zone encryption methodology, the host key encrypted data block is included within a message format supported by the local zone security protocol. This local zone emulated message is thus passed to local zone components for emulated processing pursuant to a host encryption scheme. The host key encrypted data is then extracted from the local zone emulated message and passed to the host computer. This may be accomplished by emulation of an encryption security module that is connected to a site controller. As a result, components of the traditional dual-zone methodology can be employed in a system utilizing a host key encryption data entry device. The present invention may be utilized in a number of different retail establishments, such as a retail fueling environment.

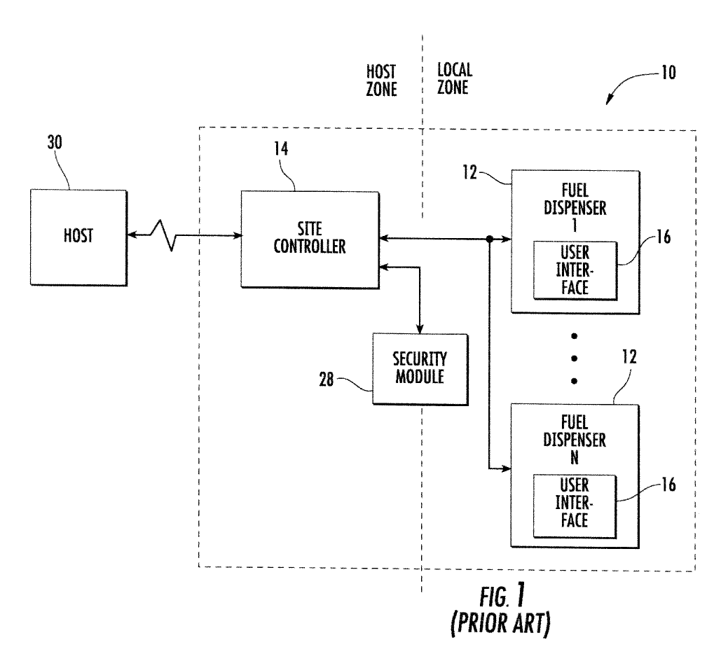

Before explaining further aspects of the present invention, it is helpful to review certain aspects of the prior art. In this regard, FIG. 1 illustrates a retail fueling environment 10 in accordance with the prior art. Environment 10 includes N fuel dispensers 12 connected to a site controller 14. Fuel dispensers 12 may be the ENCORE® or ECLIPSE® fuel dispensers sold by the assignee of the present invention, Gilbarco Inc., of 7300 W. Friendly Avenue, Greensboro, N.C. 22087. Site controller 14 may be the G-SITE® also sold by Gilbarco Inc. Other fuel dispensers and/or site controllers could also be used if needed or desired. Sometimes site controller 14 may not be made by the same manufacturer as the fuel dispensers 12; in which case, certain proprietary protocols may not be fully compatible. An optional translator may be used to make the elements compatible, as is well known.

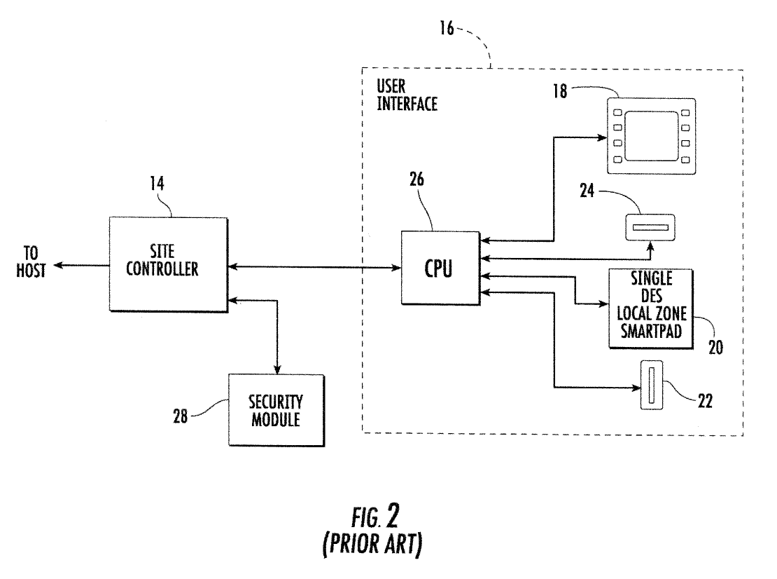

As shown, fuel dispensers 12 may each have at least one user interface 16. Referring now also to FIG. 2, each user interface 16 includes a display 18 (such as a touch screen display), a smart pad 20, a card reader 22 and a receipt printer 24. More information about a suitable smart pad is provided in U.S. Pat. No. 6,736,313, incorporated herein by reference. An additional “dumb” keypad may also be provided for selection of functions that do not require encryption (such as “call attendant”). Each of these peripheral devices communicates with an on-board central processing unit (CPU) 26.

In use, the customer may swipe her debit card in card reader 22 and enter her personal identification number (PIN) at smart pad 20. Collectively, display 18 (if equipped with a touch pad), smart pad 20, card reader 22 and any optional keypad are referred to as data entry point devices. The user interface 16 encrypts the card number and the PIN according to a local encryption scheme. Further details about such encryption can be found in the previously incorporated '084 and '313 patents. Encryption of the information reduces concerns about sending the information over communication media on which the information may be intercepted.

The encrypted information is sent to a security module 28 through site controller 14. Security module 28 decrypts the encrypted information using the local zone's encryption scheme and then re-encrypts it using a host encryption scheme. The re-encrypted information is passed back to site controller 14, which sends the re-encrypted information to a host computer 30 (FIG. 1). The transmission to host computer 30 may be over a telephone line, a packet network or the like.

The purchaser of a prior art site controller specified which encryption scheme to use in the local zone and which encryption scheme to use in the host zone. Exemplary encryption schemes included, but were not limited to pretty good privacy (PGP), Rivest-Shamir-Adelman (RSA), Data Encryption Standard (DES), and Diffie-Hellman (DH) algorithms. More information about the RSA and DH algorithms can be found in U.S. Pat. Nos. 4,405,829; 4,200,770; and 4,797,920, all of which are hereby incorporated by reference. The specification of a particular encryption scheme was dictated in large part by encryption schemes used by the data entry point devices and the host network. In the illustrated system, smart pad 20 utilizes a single-DES local zone DUKPT encryption. During the manufacturing process, the security module was programmed or configured to support the specific encryption scheme.

Recent requirements imposed by the payment card industry (PCI) will mandate the use of data entry devices utilizing certain host encryption protocols. For example, it is expected that many new fuel dispensers installed in the future will utilize keypads having triple-DES DUKPT encryption. Thus, most encryption will occur at the keypad itself rather than in the security module as described above. Because the data entry device will provide host encryption, there is no need for the dual zone encryption methodology utilized in the past. This eliminates the need for the security module, but it also requires extensive changes (and/or replacement) of the site controller and the user interface CPU. In addition, many retail establishments are already equipped with equipment intended to operate in two zones. As presently configured, this equipment would be incompatible with the new encrypting PIN pads (EPPs).

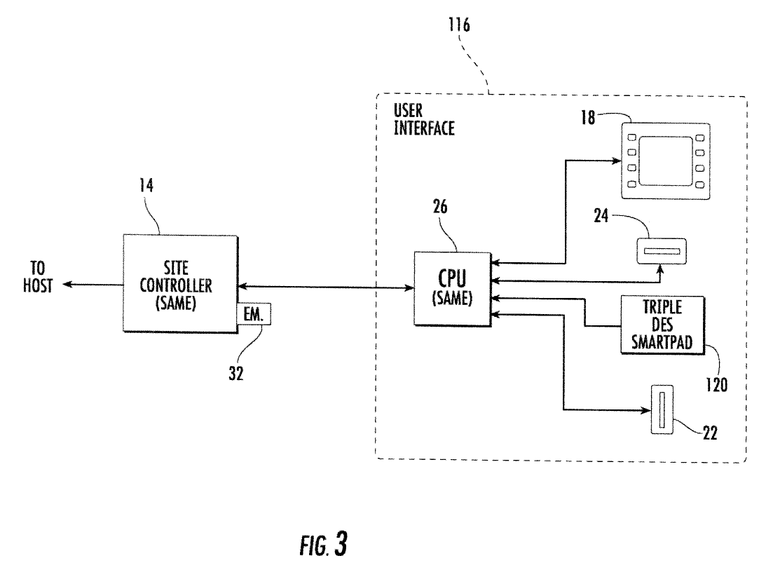

Referring now to FIG. 3, the present invention allows the use of a data entry device having a host encryption scheme without extensive modification to existing dual zone equipment. As can be seen, user interface 116 is equipped with an encrypting pin pad 120. In this case, pad 120 may be a triple-DES DUKPT that holds host keys. Pad 120 (along with display 18, card reader 22 and receipt printer 24) is in electrical communication with CPU 26. CPU 26 communicates with site controller 14, which itself communicates with the host.

Unlike pad 20, pad 120 holds host keys and therefore directly encrypts the user PIN according to the host encryption scheme. In order to allow continued use of existing dual zone components, pad 120 is configured to include the host encrypted data in a local zone emulated message. In other words, the message is formatted so that the block of host encrypted information will be contained in a format that the dual zone equipment expects to see. As a result, the hardware and software of CPU 26 can remain the same. Similarly, the hardware and software of site controller 14 can remain unchanged (except for the possible addition of an emulation software component as described below).

The software running on site controller 14 will attempt to send the local zone emulated message to the security module for decryption and re-encryption as discussed above. Because the data is already encrypted according to the host encryption scheme, however, there is no need for decryption and subsequent re-encryption. Instead, the host encrypted data simply needs to be extracted from the local zone emulated message and provided to the host. This can be accomplished by an update to the security module software. Alternatively, the security module can be eliminated and replaced with a low cost security module emulator.

In this regard, FIG. 3 shows a dongle 32 configured to emulate the previous security module. Rather than decrypting and re-encrypting the data received from site controller 14, dongle 32 merely extracts the host encrypted data from the local zone emulated message and returns that to site controller 14. The dongle may be simply plugged into the port on the site controller where the security module is conventionally connected. By emulating the security module, information encrypted with a host key could be passed through the host system without decryption and re-encryption.

For PC-based systems, an additional application could be provided that intercepts data from the COM port and pretends to be the security module. In particular, the emulated security module can execute on a Windows PC as an application that listens to the COM port and returns the expected data. Port assignments may be changed within low level software drivers to emulate the transmission and receipt of information to and from a security module. This approach would require no changes to the site controller software itself and results in a virtually “zero cost” emulator since no hardware is required to perform this function.

Either a hardware or software emulator would function in essentially the same way. That is, when the site controller sends the message to the emulator, it simply echoes back the key serial number (KSNR) and PIN block because it is already property encrypted. In particular, the keypad holds the triple-DES network key and also implements full smart pad protocols. It sets up a dummy “local encryption zone” along with the emulator so that site controller 14 and CPU 26 observe no changes with local zone messages. When user PINs are encrypted, the PINs are encrypted with the payment network key. In setting up the “local encryption zone,” the emulator implements the full protocol of the security module. The dummy “local encryption zone” is created so that site controller 14 observes no changes when “local zone messages” are sent between the emulator and the dispensers.

In an especially preferred embodiment, pad 120 functions to fake Diffie-Hellman (DH) key exchange with site controller 14. Because pad 120 holds the triple-DES DUKPT, it sends PIN block encrypted under acquirer DUKPT rather than the DH key of pad 20. In such embodiments, the emulator exchanges “fake” DH keys with user interface 116.

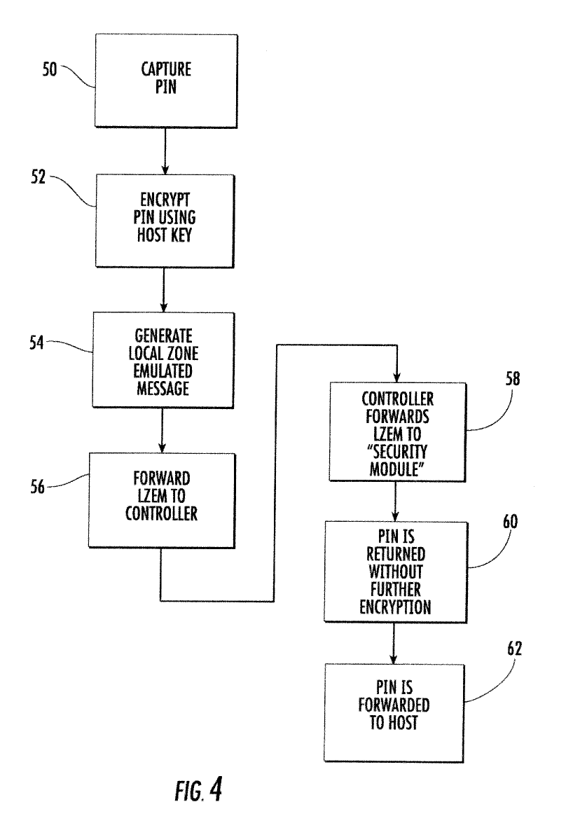

The overall process can be more easily explained with reference to FIG. 4. The user PIN is captured by pad 120 (as indicated at step 50) and encrypted using the host key (as indicated at step 52). Pad 120 then generates a local zone emulated message (LZEM) (as indicated at step 54) which is forwarded to the site controller (as indicated at step 56). The LZEM is forwarded by the site controller to the emulated “security module” (as indicated at step 58). The PIN is returned by the emulated “security module” to the controller without further encryption (as indicated at step 60). Finally, the encrypted PIN is forwarded to the host (as indicated at step 62).

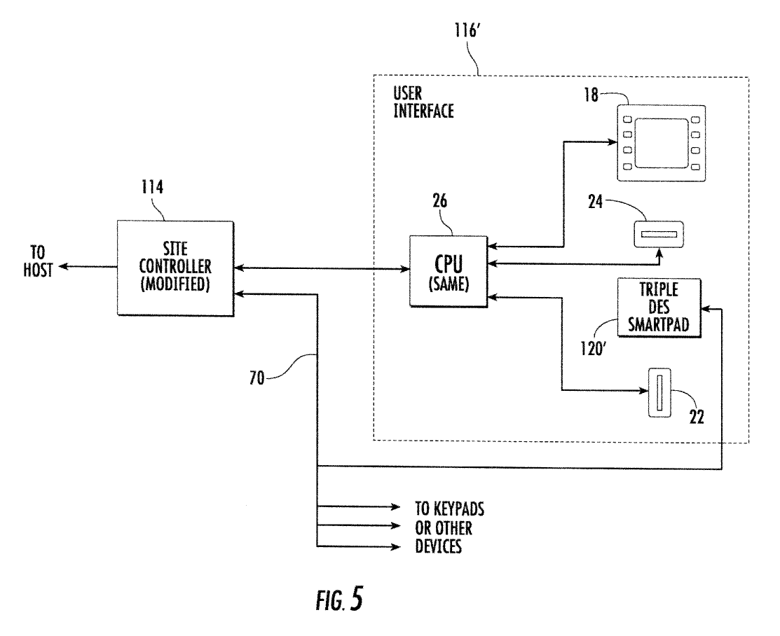

Referring now to FIG. 5, an alternative embodiment avoids the security module emulator but requires modification to the site controller. In this regard, FIG. 5 illustrates an alternative embodiment in which an “off-the-shelf” encrypting PIN pad 120′ is connected to a local area network (LAN) 70 in communication with a modified site controller 114. This avoids the need to connect pad 120′ to CPU 26 as before. Controller 114 is adapted to address pad 120′ and other keypads in the forecourt on a selected basis. As modified, site controller 114 recognizes that the PIN data received from pad 120′ is already in the host encryption format. No other changes to the user interface 116′ are required. The LAN 70 could be connected to a separate device in electrical communication with site controller 114, or it could be connected to site controller 114 directly, depending on the configuration and capabilities of the requisite hardware.

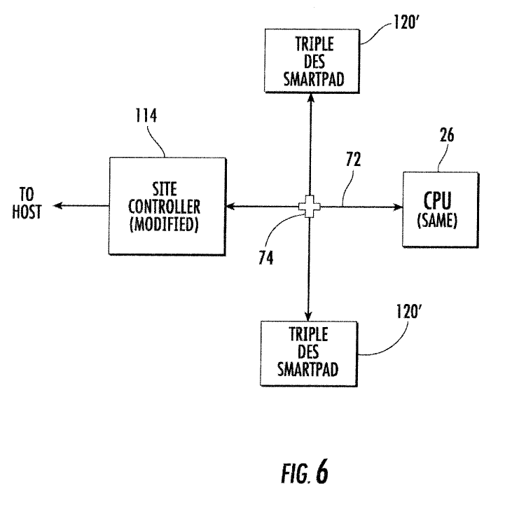

An additional modification to the embodiment of FIG. 5 is illustrated in FIG. 6. In this case, smart pads 120′ are connected into the same LAN 72 to which the various user interfaces are connected. (As FIG. 6 illustrates, a pair of pads 120′ may be provided on respective sides of a particular fuel dispenser.) An appropriate splitter 74 is inserted into the existing wiring of LAN 72 to permit the addition of new devices. The splitter may also provide appropriate power conversion. While a hard-wired LAN is illustrated, one skilled in the art will recognize that other suitable communication protocols such as wireless may be utilized.

In the embodiments of FIGS. 5 and 6, it will be appreciated that a standard EPP can be utilized because there is no need to set up a dummy local encryption zone. Instead, site controller 114 talks directly to the EPP using separate poll addresses and message protocols.

It can thus be seen that the present invention allows use of a pad that encrypts according to a host encryption scheme in an existing dual zone encryption environment. In particular, the present invention provides emulation of a first encryption protocol and allows a passthrough operation of data encrypted with a second encryption protocol. The emulation of the first encryption protocol may be accomplished with either hardware or software.

For example, an existing single-DES smart pad may be replaced with a triple-DES PIN entry device and a security module emulator (either hardware or software) to allow transmission of the triple-DES DUKPT in blocks directly to the payment network. This can be accomplished with little or no changes to the existing dual zone components.

While one or more preferred embodiments of the invention have been described above, it should be understood that any and all equivalent realizations of the present invention are included within the spirit and scope thereof. The embodiments depicted are presented by way of example and are not intended as limitations upon the present invention. Thus, those of ordinary skill in the art should understand that the present invention is not limited to these embodiments since modifications can be made. Therefore, it is contemplated that any and all such embodiments are included in the present invention as may fall within the scope and spirit thereof.

What is claimed is:

1. A system used in a retail environment for providing secure communication of payment information to a host computer, said system comprising:
at least one keypad device configured to receive personal information, said keypad device operative to encrypt said personal information according to a first encryption scheme to produce encrypted personal data;
said keypad device being further operative to generate a local zone emulated message in a message format of a second encryption scheme, said local zone emulated message containing said encrypted personal data;
a site controller in communication with said keypad device to receive said local zone emulated message, said site controller being configured to provide a message in said second encryption scheme to a security module for decryption and re-encryption in said first encryption scheme;
an emulator associated with said site controller to emulate said security module, said emulator being operative to receive said local zone emulated message and return said encrypted personal data without decryption; and
said site controller providing said encrypted personal data to said host computer according to said first encryption scheme.

2. A system as set forth in claim 1, wherein said first encryption scheme is triple-DES encryption.

3. A system as set forth in claim 2, wherein said second encryption scheme is single-DES encryption.

4. A system as set forth in claim 1, wherein said emulator comprises a hardware device connected to said site controller.

5. A system as set forth in claim 1, wherein said emulator is a configured as emulation software running on said site controller.

6. A system as set forth in claim 5, wherein said site controller utilizes a personal computer on which said emulation software runs.

7. A system used in a retail environment for providing secure communication of payment information to a host computer, said system comprising:
at least one keypad device configured to receive personal information, said keypad device operative to encrypt said personal information according to a host encryption scheme to produce encrypted personal data;
a site controller in communication with said keypad device via a local area network on which said keypad device has a network address, said site controller operative to receive said encrypted personal data; and
said site controller providing said encrypted personal data to said host computer.

8. A system as set forth in claim 7, comprising a plurality of said keypad devices each being identified by a different network address.

9. A system as set forth in claim 8, wherein said local area network is a forecourt LAN in a fuel dispensing environment.

10. A system as set forth in claim 7, wherein said host encryption scheme is triple-DES encryption.
